(19) United States
(12) Patent Application Publication
(10) Pub. No.: US 2012/0008639 A1
(43) Pub. Date: Jan. 12, 2012

(54) System and Method for Operating with Groups of Communications Devices in a Wireless Communications System

(75) Inventor: Bin Chen, Schaumburg, IL (US)

(73) Assignee: FutureWei Technologies, Inc., Plano, TX (US)

(21) Appl. No.: 13/048,276

(22) Filed: Mar. 15, 2011

Related U.S. Application Data
(60) Provisional application No. 61/363,412, filed on Jul. 12, 2010.

(51) Int. Cl. H04J 3/16

(52) U.S. Cl. 370/437

(57) ABSTRACT

A system and method for operating with groups of communications devices in a wireless communications system are provided. A method includes for each flow in at least one flow associated with communications devices in a group of communications devices served by a communications controller, determining a set of parameters for the flow, and transmitting the set of parameters to a communications device associated with the flow.

This application claims the benefit of U.S. Provisional Application No. 61/363,412, filed on Jul. 12, 2010, entitled “Method for Security and Flexibility in Group Resource Allocation,” which application is hereby incorporated herein by reference.

### TECHNICAL FIELD

The present invention relates generally to digital communications, and more particularly to a system and method for operating with groups of communications devices in a wireless communications system.

### BACKGROUND

Wireless broadband access systems have changed the way that their users work and enjoy information access. No longer are users of wireless broadband access systems restricted to specific locations with wireline access to information services. In fact, users are free to move wherever they like within a coverage area and still have rapid access to information that they need and/or desire.

FIG. 1 illustrates a prior art communications system 100. Communications system 100 includes a base station (BS) 100, which may also be referred to as a controller, a communications controller, a NodeB, an enhanced NodeB, and so forth. BS 100 may serve one or more mobile stations (MS), such as mobile stations 110 through 115. Mobile stations may also be referred to as mobiles, subscribers, terminals, users, User Equipment, and so on. BS 100 may serve a mobile station by allocating resources for transmissions to and/or from the mobile station.

Generally, BS 100 may inform a MS where (in terms of resources) to expect a transmission from BS 100 or begin a transmission to BS 100. BS 100 may individually provide resource information to the MSs. However, if BS 100 is serving a number of MSs, transmitting individual resource information messages to each of the MSs may incur significant signaling overhead, which may negatively impact overall communications system performance.

Therefore, there is a need to provide resource information to MSs served by a BS without incurring significant signaling overhead.

### SUMMARY OF THE INVENTION

These and other problems are generally solved or circumvented, and technical advantages are generally achieved, by example embodiments of the present invention which provides a system and method for operating with groups of communications devices in a wireless communications system

In accordance with an example embodiment of the present invention, a method for communications controller operations is provided. The method includes for each flow in at least one flow associated with communications devices in a group of communications devices served by a communications controller, determining a set of parameters for the flow, and transmitting the set of parameters to a communications device associated with the flow.

In accordance with another example embodiment of the present invention, a method for communications controller operations is provided. The method includes for each message flow in a plurality of flows associated with communications devices in a group of communications devices served by a communications controller, configuring a set of parameters for the flow, selecting at least two flows from the plurality of flows, and for each selected flow in the at least two flows, selecting a parameter from a set of parameters associated with the selected flow, transmitting an indication of the parameter to a selected communications device associated with the selected flow, and transmitting to the selected communications device, wherein the transmitting is based on the parameter. The set of parameters is set based on a selection criterion and requirements of the flow.

In accordance with another example embodiment of the present invention, a communications controller is provided. The communications controller includes a parameter configure unit, a parameter select unit coupled to the parameter configure unit, and a transmitter coupled to the parameter configure unit and to the parameter select unit. The parameter configure unit configures a set of parameters for each flow in a plurality of flows associated with communications devices in a group of communications devices served by the communications controller. E each set of parameters is based on selection criteria and requirements of an associated flow. The parameter select unit selects a parameter from a set of parameters assigned to a flow in the plurality of flows, and the transmitter transmits the sets of parameters to a first plurality of communications devices associated with the plurality of flows in a first group allocation message and transmits a selected parameter to a second plurality of communications devices.

One advantage disclosed herein is that a burst size set may be MS specific and not group specific, thereby providing a greater degree of flexibility in assigning resources to MSs.

A further advantage of exemplary embodiments is that resource offsets may be individually provided to MSs in a group, thereby reducing computational requirements for the MSs in the group since the MSs do not need to compute a location of their allocated resources.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example prior art communications system;

FIG. 2 illustrates an example technique for reducing signaling overhead in providing resource information to MSs;

FIG. 3 illustrates an example technique for reducing signaling overhead in providing resource information to MSs according to example embodiments described herein;

FIG. 4a illustrates an example flow diagram of operations 400 occurring in a BS for transmitting to one or more MSs in a group of MSs, wherein a technique for reducing resource allocation signaling overhead is utilized according to example embodiments described herein;

FIG. 4b illustrates an example flow diagram of operations 450 occurring in a MS for receiving transmissions from a BS, wherein the BS is using a technique for reducing resource allocation signaling overhead according to example embodiments described herein;

FIG. 5a illustrates an example flow diagram of operations 500 for configuring burst sizes according to example embodiments described herein;

FIG. 5b illustrates an example flow diagram of operations 520 for indicating burst sizes according to example embodiments described herein;

FIG. 5c illustrates an example flow diagram of operation 540 for processing burst sizes according to example embodiments described herein;

FIG. 5d illustrates an example flow diagram of operations 560 for determining resource location according to example embodiments described herein;

FIG. 6a illustrates an example flow diagram of operations 600 for configuring burst and/or resource sizes according to example embodiments described herein;

FIG. 6b illustrates an example flow diagram of operations 620 for indicating resource sizes according to example embodiments described herein;

FIG. 6c illustrates an example flow diagram of operation 640 for processing resource sizes according to example embodiments described herein;

FIG. 6d illustrates an example flow diagram of operations 660 for determining resource location according to example embodiments described herein;

FIG. 7a illustrates an example flow diagram of operations 700 for configuring burst and/or resource sizes according to example embodiments described herein;

FIG. 7b illustrates an example flow diagram of operations 720 for indicating resource offsets according to example embodiments described herein;

FIG. 7c illustrates an example flow diagram of operation 740 for processing burst sizes and/or resource sizes according to example embodiments described herein;

FIG. 7d illustrates an example flow diagram of operations 760 for determining resource location according to example embodiments described herein;

FIG. 8 provides an example illustration of a communications device according to example embodiments described herein; and

FIG. 9 provides an example illustration of a communications device according to example embodiments described herein.

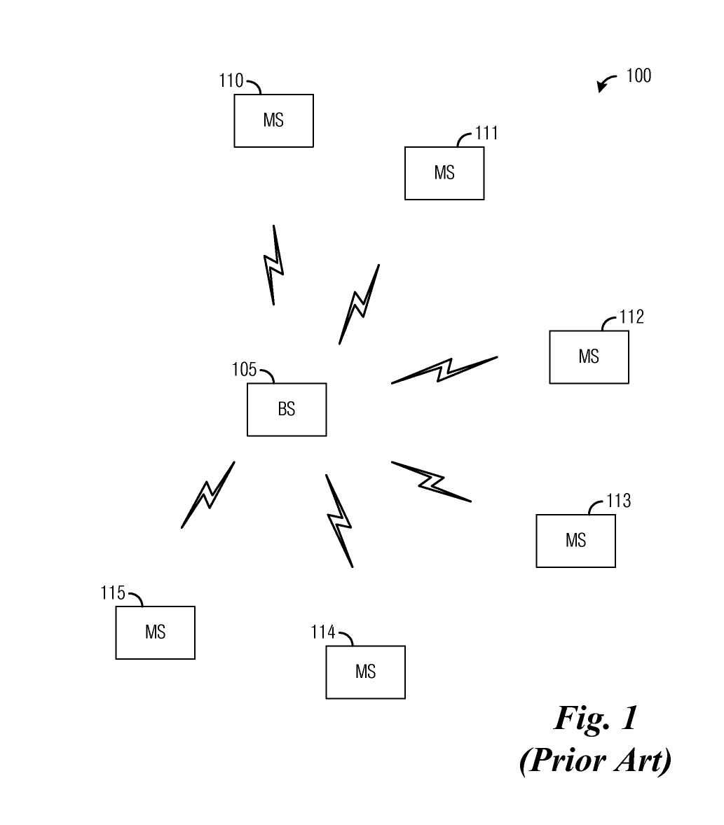

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a WiMAX compliant communications system that signals resource allocations using an A-MAP. The invention may also be applied, however, to other communications systems that signal resource allocations, such as 3GPP WCDMA/HSDPA, 3GPP LTE, 3GPP LTE-Advanced, and so forth.

A Group Resource Allocation mechanism allocates resources to multiple MSs as a group in order to save control overhead. Group Resource Allocation may be used for connections with a periodic traffic pattern and with relatively fixed payload size, for example. Grouping criteria include Multiple Input, Multiple Output (MIMO) modes and Hybrid Automatic Repeat Requested (HARQ) burst sizes. As a result, every group may correspond to a given set of MIMO modes, and HARQ burst sizes. A flow of an Adaptive MIMO Switch (AMS) may be assigned to a Downlink (DL) and/or an Uplink (UL) group. Each DL or UL group is identified by a unique 12-bit Group ID allocated from group IDs. Dynamic changes within the limited set of MIMO modes and HARQ data burst sizes are facilitated within a group. In general, a burst size may also be referred to as a transmission size.

The Advanced Base Station (ABS) configures a Group MIMO Mode Set for each group among the predefined candidate sets specified in technical specifications for the UL. When a flow is added into the group, the configured Group MIMO Mode Set ID is indicated through a Group Configuration Media Access Control (MAC) control message. The assigned MIMO mode to a flow in the group shall be chosen from the configured set.

The ABS configures a HARQ Burst Size Set for each group. Each HARQ burst size set supports four HARQ burst sizes. The Group Configuration MAC control message signaled to a flow contains the HARQ burst sizes assigned to its group. The assigned HARQ burst size to a flow in the group shall be chosen from the configured set.

The ABS uses bitmaps to signal resource allocation information for flows within a group. These bitmaps are sent in the Group Resource Allocation (GRA) A-MAP Information Element (IE). The first bitmap is the User Bitmap which uses 1 bit per flow to signal which users are scheduled in the frame. The user bitmap size can be 8, 16 or 32 bits. Each flow belonging to the group shall be assigned a unique index in the User Bitmap of that group. The bitmap size for a given group shall remain fixed. As flows are deleted from the group, some bit indices in the user bitmap may become empty or unassigned. These empty bits may be assigned to new flows of existing or new users as they are added to the group.

The third bitmap is the Resource Allocation bitmap which uses 2 bits per flow to signal HARQ burst size and 3 bits per flow to signal the Resource Size for the scheduled flow in the AAI subframe or extended AAI subframe that are scheduled in the frame. The resource size refers to the number of logical resource units (LRUs) allocated to the flow. The resource size supported in GRA is limited to 16 LRUs. Each group supports eight resource sizes for each burst size supported in the group. The set of resource sizes for each burst size belong to the range [1,16] LRUs. The set of HARQ burst sizes and resource sizes supported in the group is signaled in the Group Configuration MAC control message. For groups corresponding to all MIMO mode sets except UL (0b11), AMS i calculates the starting location of resources of its flow with index i in the AAI subframe as follows

$${R}_{i} = {R}_{0} + {\sum }_{j = 1}^{j < i} {L}_{j} ,$$

Where R₀ is the resource offset of the group as signaled in the DL/UL Group Resource Allocation A-MAP IE and Lⱼ is the resource size in LRUs of the flow in the group whose user bitmap index is j.

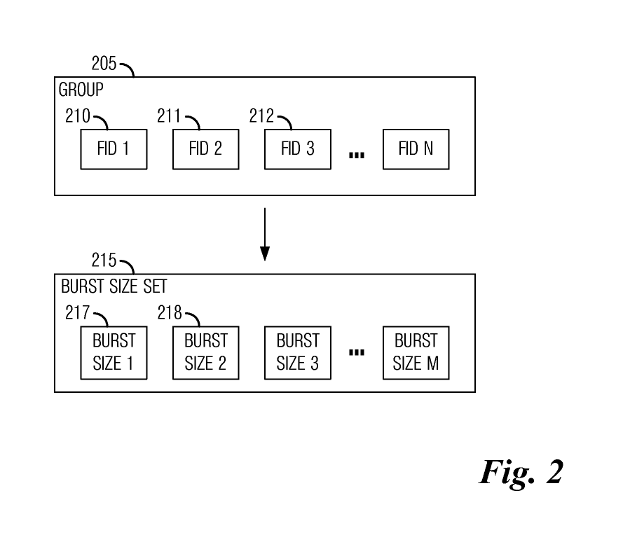

FIG. 2 illustrates a technique for reducing signaling overhead in providing resource information to MSs. In many wireless communications systems, e.g., IEEE 802.16 (also commonly referred to as WiMAX) compliant communications systems, a physical resource referred to as a MAP or an A-MAP may be used to allocate radio resources to the MSs. Typically, one MAP message is used to allocate radio resources to one MS. In IEEE 802.16m, a mechanism referred to as group resource allocation can allocate radio resources to multiple MSs with a combined A-MAP message. However, the combined A-MAP message may be large, requiring several A-MAP bursts to transmit the entire combined A-MAP message.

As shown in FIG. 2, a BS may signal resource information to multiple MSs arranged in a group of MSs 205. A group of MSs comprises MSs served by the BS and may or may not have any association with one another. Group of MSs 205 may include one or more MSs, where the MSs in group of MSs 205 may be addressed by one or more flow identifiers (FID). A FID is a unique identifier for an information stream to and from a MS. A FID may identify a message flow, a data flow, or so on. A MS may have one or more FIDs. For example, FID 1 210 may belong to a first MS, while FID 2 211 and FID 3 212 may belong to a second MS. In general, a group of MSs may include N FIDs for K MSs, where N and K are integer values and N≧K. Therefore, multiple FIDs may map to a single MS, however, the FID to MS mapping is unambiguous, meaning that a single FID maps to a single MS.

A group of MSs may be identified with a group identifier (e.g., group ID). Each FID associated with MSs in a group of MSs may be allocated an identity referred to as a bitmap index, which indicates its location in a user bitmap in a group allocation A-MAP or group allocation message. Typical size values of the user bitmap may be four, eight, 16, 32, or so on, bits which appear in the group allocation A-MAP to indicate which FIDs are allocated resources in the group allocation A-MAP. When a bit in the user bitmap is set to one, then a corresponding FID has a resource allocation information element included in the group allocation A-MAP.

For the FIDs associated with MSs in group of MSs 205, there may be a set of burst sizes (shown in FIG. 2 as burst size set 215) which specify possible transmission burst sizes for each FID associated with MSs in group of MSs 205. Burst size set 215 includes M different burst sizes, including burst size 1 217 and burst size 2 218, which may be allocated to the FIDs in group of MSs 205. According to the WiMAX technical standards, M may be equal to four, however, in general, M may be any positive integer value. The BS may allocate the same burst size to all of the FIDs or different burst sizes to different FIDs in group of MSs 205. There may be a single set of burst sizes for all FIDs associated with MSs in group of MSs 205, however, the BS may determine an actual burst size allocated to each FID. After allocating a burst size to a FID, the BS may signal the allocated burst size (or an indication thereof) to the FID.

Since there is a single set of burst sizes for all of the FIDs associated with MSs in group of MSs 205, resource allocation may be limited since set of burst sizes may be limited. Furthermore, each MS in group of MSs 205 knows the set of burst sizes, therefore, it may be possible for a MS in group of MSs 205 to determine a resource allocated to a FID of another MS and possibly listen in on transmissions intended for other MSs.

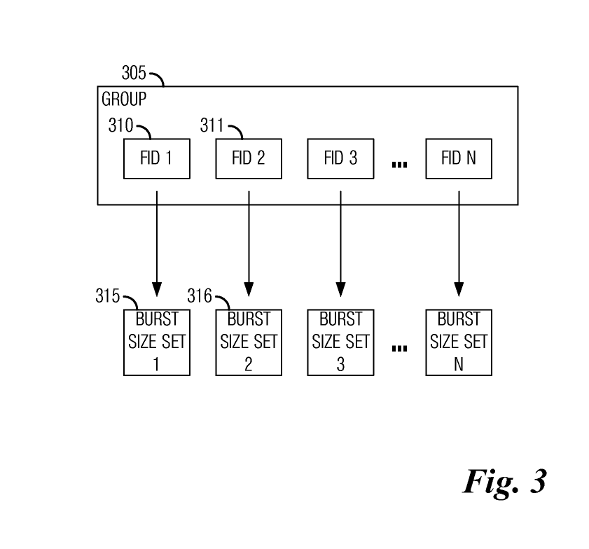

FIG. 3 illustrates a technique for reducing signaling overhead in providing resource information to MSs. Instead of using a single set of burst sizes for each FID associated with MSs in a group of MSs 305, each FID associated with MSs in group of MSs 305 may have its own set of burst sizes. As shown in FIG. 3, group of MSs 305 includes N FIDs, such as FID 1 310 and FID 2 311. Each FID associated with MSs in group of MSs 305 may be assigned a set of burst sizes, such as burst size set 1 315 may be assigned to FID 1 310 and burst size set 2 316 may be assigned to FID 2 311, for example. Assigning sets of burst sizes to individual FIDs rather than entire groups of MSs may be referred to as FID related burst size assignment rather than group related burst size assignment. In general, a total number of unique sets of burst sizes may be less than or equal to a total number of FIDs associated with MSs in group of MSs 305.

According to an example embodiment, each FID may be assigned its own set of burst sizes. However, the set of burst sizes do not have to be unique. For example, several FIDs in a group of MSs may be assigned the same set of burst sizes. According to another example embodiment, each FID associated with MSs in a group of MSs may be assigned the same set of burst sizes.

According to another example embodiment, two sets of burst sizes may be considered to be different even if they each have the same number of burst sizes, but the size of at least one of their burst sizes differ.

According to another example embodiment, two sets of burst sizes may be considered to be different even if they each have the same number of burst sizes and all of their respective burst sizes are equal in size, but the burst sizes within the two sets of burst sizes are ordered differently. As an example, consider a first set of burst sizes comprising burst size 1 with size 20 bytes, burst size 2 with size 25 bytes, and burst size 3 with size 30 bytes; and a second set of burst sizes comprising burst size 1 with size 25 bytes, burst size 2 with size 30 bytes, and burst size 3 with size 20 bytes. First set of burst sizes may be considered to be different from second set of burst sizes although the two sets of burst sizes have the same number of burst sizes and individual burst sizes in the two sets of burst sizes are equal in size.

In addition to providing greater flexibility in terms of scheduling burst sizes to FIDs (MSs), the assignment of a potentially unique set of burst sizes to each FID associated with MSs in a group of MSs may help to provide a level of security to transmissions made to MSs in the group of MSs. Consider the technique of providing resource information to MSs where all of the FIDs in the group of MSs share a single set of burst sizes. Since the FIDs know the set of burst sizes, it may be possible for a MS associated with a FID to determine which resources have been assigned to a particular FID and intercept transmissions intended for the particular FID.

However, if there is a potential for each FID to be assigned a different set of burst sizes, it may be very difficult if not impossible for a MS associated with a FID to determine which resources have been assigned to another FID and intercept transmissions intended for the other FID. Even if two sets of burst sizes have the same number of burst sizes and individual burst sizes from the two sets of burst sizes have the same size, the two sets of burst sizes may be made different by permuting the order of the burst sizes in the two sets of burst sizes.

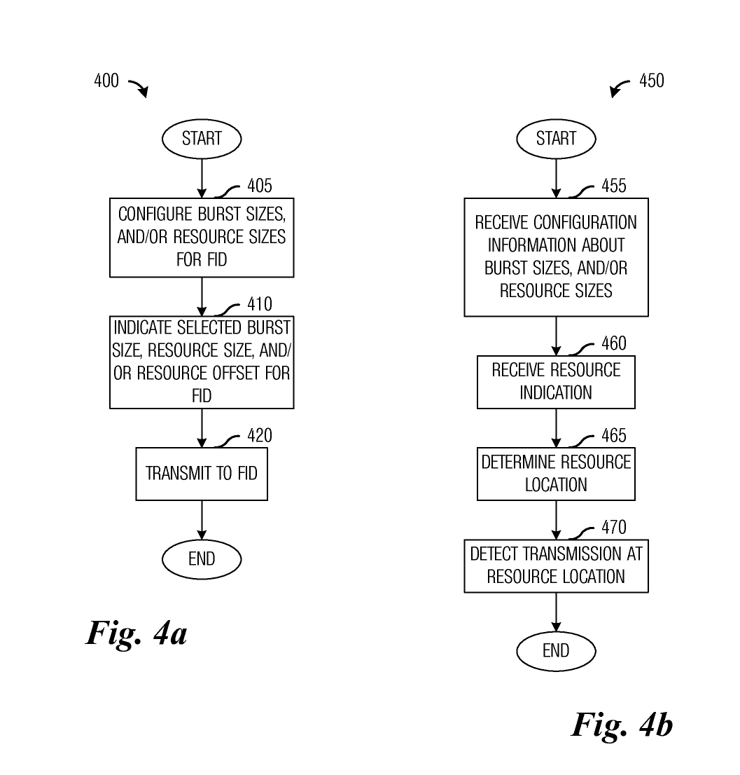

FIG. 4a illustrates a flow diagram of operations 400 occurring in a BS for transmitting to one or more MSs in a group of MSs, wherein a technique for reducing resource allocation signaling overhead is utilized. Operations 400 may be indicative of operations occurring in a BS as the BS transmits to one or more MSs in a group of MSs as the BS makes use of a technique for reducing resource allocation signaling overhead. Operations 400 may occur while the BS is in a normal operating mode and is serving one or more MSs.

Operations 400 may begin with the BS configuring sets of burst sizes for the one or more FIDs associated with MSs in the group of MSs (block 405). According to an example embodiment, part of configuring sets of burst sizes for the one or more FIDs may include assigning a set of burst sizes to each of the one or more FIDs, indicating each of the one or more FIDs the assigned set of burst sizes, indicating individual burst sizes in the set of burst sizes, and so forth. The BS may signal the set of burst sizes, burst sizes, and so on, to the FIDs associated with MSs in the group of MSs.

According to an example embodiment, instead of or in combination with configuring sets of burst sizes, the BS may also configure resource sizes (also referred to as transmission resource sizes) and/or resource offsets (also referred to as resource location offsets) for the one or more FIDs associated with MSs in the group of MSs. The resource sizes and/or resource offsets may be signaled to the FIDs associated with MSs in the group of MSs.

According to an example embodiment, the configuring of the sets of burst sizes (and/or resource sizes, resource offset, and so forth) for the one or more FIDs may be based on selection criteria based on requirements of the FIDs. Examples of selection criteria include bandwidth requirements of the FID, the FID's priority, the FID's quality of service requirements, available bandwidth of the communications system, communications system load, communications system utilization, and so on.

Generally, a resource size, when used in conjunction with burst size, may be used to specify a modulating and coding scheme (MCS) for a transmission to a FID. Therefore, the BS may configure a resource size for the one or more FIDs. If one of the two, i.e., the resource size or the burst size, is unknown to an unintended recipient, it may be difficult for the unintended recipient to determine information contained within the transmission.

Additionally, in order for a MS to detect a transmission, the MS needs to know where to perform its detection of the transmission. Ideally, the MS may begin detection right at when the transmission is to begin and stop detection right when the transmission is to stop in order to minimize power consumption and processing overhead spent in performing needless detection. The MS may determine when to begin detection by computing its own resource offset. However, to help reduce computational overhead at the MS, the BS may provide the resource offset to the FID associated with the MS.

The BS may then select a burst size for a FID from a set of burst sizes assigned to the FID and send an indication for the burst size, e.g., an index associated with the burst size in the set of burst sizes, to the MS (block 410). According to an example embodiment, the BS may send indications of burst size for each of the FIDs associated with MSs in the group of MSs in a group allocation A-MAP. For example, the BS may send a sequence of <FID identifier, burst size indicator> pairs. As an example, the BS may send a numerical representation of the index of the burst size in the set of burst sizes to the MS. Alternatively, the BS may send a bitmap representative of the set of burst sizes with a bit corresponding to the burst size set to a specified value.

According to an embodiment, the BS may select burst sizes for FIDs that are to be receiving transmissions. The BS may not select burst sizes for FIDs that are not receiving transmissions. Therefore, BS may not transmit any burst size information to MSs of FIDs that are not receiving transmissions.

Furthermore, if the BS configured the resource size and/or the resource offset, the BS may send information related to the resource size and/or the resource offset to the MS. The BS may then transmit to the FIDs associated with MSs in the group of MSs (block 420).

According to an example embodiment, the selection of the burst size (and/or resource sizes, resource offset, and so forth) for the one or more FIDs may be based on performance criteria based on requirements of the FIDs. Examples of performance criteria include: amount of transmission to be made to FID, FID priority, FID quality of service requirements, service history for FID, current communications system traffic and load, expected communications system's load, available communications system resources, and so forth.

Although the discussion presented herein focuses on DL communications, the example embodiments may also be applicable to UL communications. Therefore, the discussion of DL communications should not be construed as being limiting to either the scope or the spirit of the example embodiments.

FIG. 4b illustrates a flow diagram of operations 450 occurring in a MS for receiving transmissions from a BS, wherein the BS is using a technique for reducing resource allocation signaling overhead. Operations 450 may be indicative of operations occurring in a MS as the MS receives transmissions from a BS that is serving the MS as the BS makes use of a technique for reducing resource allocation signaling overhead. Operations 450 may occur while the MS is in a normal operating mode and is being served by the BS.

Operations 450 may begin with the MS receiving configuration information about a set of burst sizes assigned to the FID associated with the MS (block 455). According to an embodiment, the BS serving the MS may select and assign a set of burst sizes to the FID(s) associated with the MS, wherein the set of burst sizes assigned to the FID may be different from other sets of burst sizes assigned to other FIDs associated with MSs in a group of MSs that includes the MS. The BS may then send configuration information regarding the set of burst sizes to the MS. As an example, the BS may send to the MS an indication of a number of burst sizes in the set of burst sizes, a size of each of individual burst sizes in the set of burst sizes, and so forth.

Furthermore, in addition to or in lieu of the set of burst sizes, the BS may configure a resource size(s) and/or a resource offset(s) for the FID, which it may also transmit to the MS associated with the FID. According to an example embodiment, the BS may send the resource size(s) and/or resource offset(s) to the MS or indications of the resource size(s) and/or resource offset(s) to the MS.

The MS may also receive an indication for a resource, such as an indication for a burst size, an indication for a resource size, an indication of a resource offset, and so forth, from the BS (block 460). According to an example embodiment, when the BS has a transmission to make to the MS, the BS may select a burst size commensurate to the transmission and send the selected burst size or an indication of the selected burst size to the MS.

Using the indication for the resource, the MS may determine a resource location for where and/or when it should begin detecting for the transmission (block 465). As an example, in a group allocation, the MS may make use of information related to other FIDs that where transmitted before its own indication to determine the resource location. Alternatively, if the indication for the resource comprises a resource offset, the MS may not need to consider information related to other FIDs to determine the resource location unless the resource offset is a relative resource offset. The MS may then detect the transmission made by the BS by starting its detection at the resource location and continuing for a burst size as indicated by the BS (block 470).

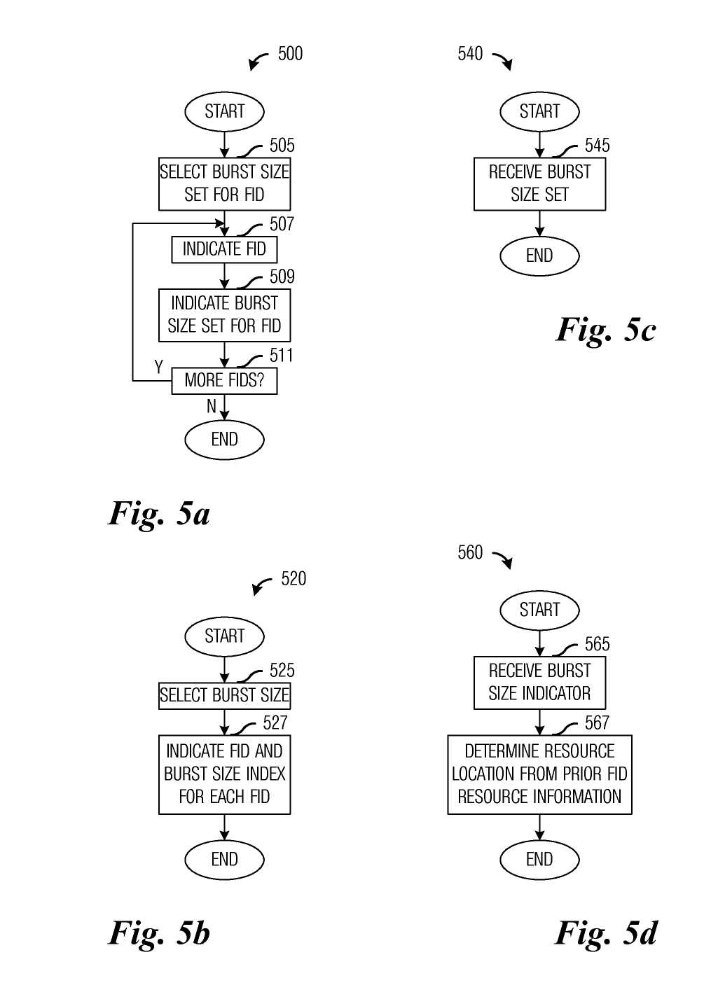

FIG. 5a illustrates a flow diagram of operations 500 for configuring burst sizes. Operations 500 may be indicative of operations occurring in a BS as the BS configures burst sizes for FIDs of MSs served by the BS. Operations 500 may be an implementation of block 405 of FIG. 4a, configure burst sizes, resource sizes, and/or resource offset for FID. Operations 500 may occur while the BS is in a normal operating mode and has MSs to serve.

Operations 500 may begin with the BS selecting a set of burst sizes for each FID associated with MSs in a group of MSs served by the BS (block 505). According to an embodiment, the BS may select a set of burst sizes for a FID based on selection criteria such as bandwidth requirements of the FID, the FID's priority, the FID's quality of service requirements, available bandwidth of the communications system, communications system load, communications system utilization, and so on.

The BS may then send to each FID associated with MSs in the group of MSs information regarding a set of burst sizes selected for the FID. As an example, the BS may send an indication of a FID (block 507) and then indicate the set of burst sizes for the FID (block 509). The BS may repeat blocks 507 and 509 for each FID associated with MSs in the group of MSs (block 511).

Indicating the set of burst sizes for the FID may include the BS sending an indication of the size of the set of burst sizes selected for the FID. As an example, the BS may send a set of burst size indicator that indicates a number of burst sizes in the set of burst sizes. According to an example embodiment, the set of burst size indicator comprises a number of bits, such as zero, one, two, three, four, or any other number of bits, to indicate the number of burst sizes in the set of burst sizes. For example, if the set of burst size indicator is zero bits, then the set of burst sizes includes a single burst size, while if the set of burst size indicator is one bit, then the set of burst sizes includes two burst sizes, and so on. If the set of burst size indicator is zero bits in size, then there is just one burst size for the FID and there may be no need to include burst size information because the burst size may be as determined by a technical standard or provided to the MS in a message.

The BS may also send an index for each burst size in the set of burst size and an actual size of the burst size. For discussion purposes, consider set of burst sizes selected for FID one with four burst sizes: burst size one with 20 bytes, burst size two with 25 bytes, burst size three with 30 bytes, and burst size four with 35 bytes. The BS may send the FID information about its selected burst size by sending FID number; set of burst size indicator; burst size index, burst size; burst size index, burst size; and so on. Considering the above example, the sequence may be: one; two; 1, 20; 2, 25; 3, 30; 4, 35.

According to an example embodiment, the burst size index and the burst size may be provided to the MS in the form of a bit map, with a first portion of the bit map indicating the burst size index and a second portion of the bit map indicating the burst size itself For example, consider a five-bit bit map with two bits used to indicate the burst size index and three bits used to indicate the burst size.

The configuring of the set of burst sizes may occur over media access control (MAC) or physical (PHY) layer messages or any other type of messages. An example of a MAC message, such as a Group Configuration MAC Control (AAI_GRP-CFG) message, is shown below in Table 1. As shown in Table 1, a two-bit burst size indicator is used, therefore, there are a total of four burst sizes per set of burst sizes.

TABLE 1
MAC message used to configure burst size.

| Mandatory/ | Attributes/Array of | Size | | |
|---|---|---|---|---|
| Optional | attributes | (bits) | Value/Note | Conditions |
| M | Message type | 8 | | |
| M | Deletion Flag | 1 | Flag to signal whether this | |
| | | | message includes addition or | |
| | | | deletion information. | |
| | | | 0: Flow is added to a group | |
| | | | 1: Flow is explicitly deleted | |
| | | | from a group | |
| M | dlUlIndicato | 1 | 0: DL allocation | |
| | | | 1: UL allocation | |
| M | FID | 4 | FID that is added to or deleted | |
| | | | from GRA group | |
| M | K) Burst&Resource- | | | |
| | Info [1..4] | | | |
| M | K.1) Burst size i | 2 bits | ith burst size of the 4 burst | Present if |
| | | | sizes supported for the FID | Deletion |
| | | | | Flag == 0 |
| | . . . | | | |

FIG. 5b illustrates a flow diagram of operations 520 for indicating burst sizes. Operations 520 may be indicative of operations occurring in a BS as the BS indicates a burst size that it has allocated to a MS that is served by the BS. Operations 520 may be an implementation of block 410 of FIG. 4a, indicate selected burst size, resource size, and/or resource offset for FIG. Operations 520 may occur while the BS is in a normal operating mode and has MSs to serve.

Operations 520 may begin with the BS selecting a burst size for a FID (block 525). According to an embodiment, the BS may select the burst size from a set of burst sizes assigned to the FID. The BS may select the burst size for the FID based on a number of performance criteria, including but not limited to: amount of transmission to be made to FID, FID priority, FID quality of service requirements, service history for FID, current communications system traffic and load, expected communications system's load, available communications system resources, and so forth.

The BS may then send information related to the selected burst size to the MS (block 527). According to an example embodiment, the BS may send a number corresponding to a position or index of the selected burst size in the set of burst sizes to the MS. According to another example embodiment, the BS may send the size of the selected burst size to the MS. According to another example embodiment, the BS may send a difference between the selected burst size and a previously selected burst size to the MS. If the BS is providing burst size information to more than one FID, the BS may also send information that may be used to identify the FID along with the burst size information to the MS.

FIG. 5c illustrates a flow diagram of operation 540 for processing burst sizes. Operations 540 may be indicative of operations occurring in a MS as the MS receives configuration information about burst sizes from a BS that is serving the BS. Operations 540 may be an implementation of block 455 of FIG. 4b, receive configuration information about burst sizes, resource sizes, and/or resource offset. Operations 540 may occur while the MS is in a normal operating mode and is being served by the BS.

Operations 540 may include the MS receiving from the BS burst size information for a FID associated with the MS (block 545). According to an example embodiment, the MS may receive an indication of a burst size and an indication of a size of the burst size. The MS may receive an indication of a burst size and an indication of a size of the burst size for each of the burst sizes in a set of burst sizes assigned to the MS by the BS. For example, if the set of burst sizes assigned to the MS includes four burst sizes, then the MS may receive four indications of burst sizes and an indication of a size of each of the four burst sizes.

According to an example embodiment, even if the sets of burst sizes assigned to two FIDs include the same number of burst sizes, with each burst size being equal in size, the BS may rearrange the burst sizes to make the set of burst sizes different. As an example, consider a first set of burst size with a total of four burst sizes that are 20 bytes, 25 bytes, 30 bytes, and 35 bytes in size, respectively. However, the first set of burst sizes may be arranged so that an order of the burst sizes is 20 bytes, 25 bytes, 30 bytes, and 35 bytes. Also consider a second set of burst sizes also with four burst sizes that are also 20 bytes, 25 bytes, 30 bytes, and 35 bytes in size. However, the second set of burst sizes may be arranged so that an order of the burst sizes is 20 bytes, 30 bytes, 25 bytes, and 35 bytes. By arranging the burst sizes differently, the BS produces different sets of burst sizes.

By ensuring that different sets of burst sizes are assigned to different FIDs, a security level of transmissions to the FIDs may be made more secure since it may be difficult (if not impossible) for other FIDs to determine a burst size of a FID and therefore be able to intercept transmissions intended for the FID.

FIG. 5d illustrates a flow diagram of operations 560 for determining resource location. Operations 560 may be indicative of operations occurring in a MS as the MS determine a resource location where it should begin detection for a transmission made to the MS by a BS serving the MS. Operations 560 may be an implementation of blocks 460 and 465 of FIG. 4b, receive resource indication and determine resource location. Operations 560 may occur while the MS is in a normal operating mode and is being served by the BS.

Operations 560 may begin with the MS associated with a FID receiving an indication of a burst size selected by the BS for the FID (block 565). According to an embodiment, the indication of the burst size selected by the BS may be an index of the selected burst size. The MS may then determine the resource location where it may begin detecting for the transmission made by the BS (block 567). According to an embodiment, the MS may determine the resource location by considering the burst size of FIDs provided by the BS transmitted in resources prior to the transmission made by the BS to the MS. As an example, consider a situation wherein the MS is the fourth in a sequence of transmission made by the BS and the first three transmissions are transmissions of burst sizes 25 bytes, 25 bytes, and 40 bytes, respectively. The MS may then determine that its resource location by combining the burst sizes of the three transmissions made by the BS prior to its transmission and an initial resource location, e.g.,

resource location=initial resource location+25+25+40.

Rather than providing only burst size information, the BS may also provide resource size information. The resource size information may be provided in conjunction with the burst size information or in lieu of the burst size information.

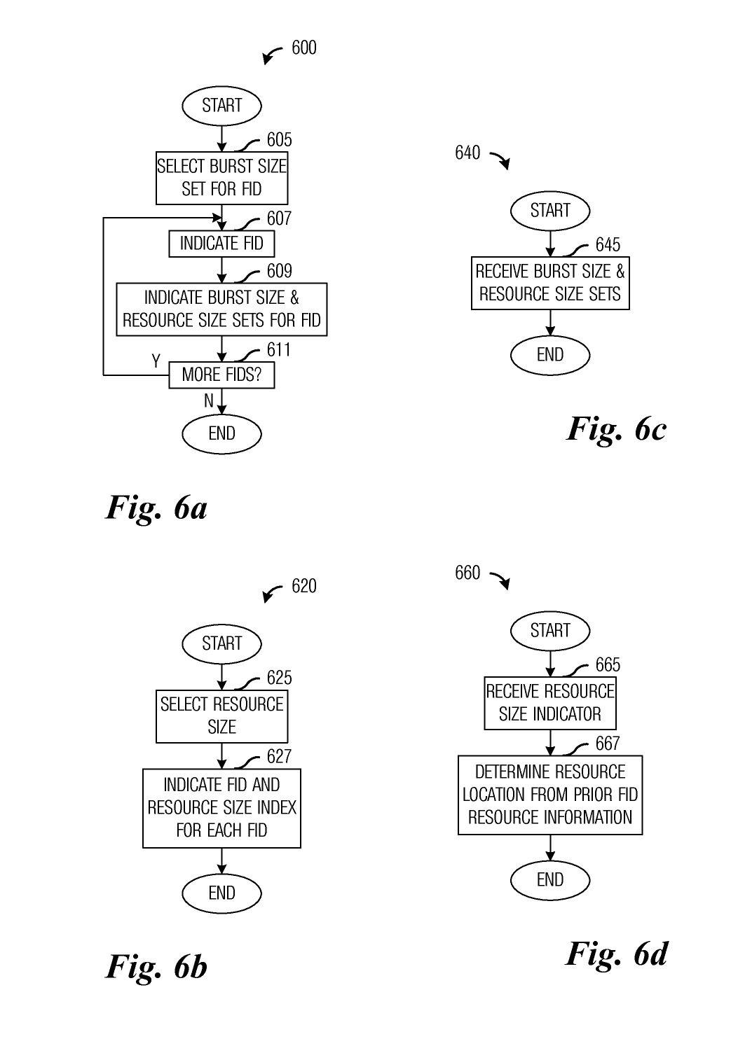

FIG. 6a illustrates a flow diagram of operations 600 for configuring burst and/or resource sizes. Operations 600 may be indicative of operations occurring in a BS as the BS configures burst and/or resource sizes for MSs served by the BS. Operations 600 may be an implementation of block 405 of FIG. 4a, configure burst sizes, resource sizes, and/or resource offset for FID. Operations 600 may occur while the BS is in a normal operating mode and has MSs to serve.

Operations 600 may begin with the BS selecting a set of burst sizes for each FID associated with MSs in a group of MSs served by the BS (block 605). According to an embodiment, the BS may select a set of burst sizes for a FID based on selection criteria such as bandwidth requirements of the FID, the FID's priority, the FID's quality of service requirements, available bandwidth of the communications system, communications system load, communications system utilization, and so on.

The BS may then send to each FID associated with MSs in the group of MSs information regarding a set of burst sizes selected for the FID. As an example, the BS may send an indication of a FID (block 607) and then indicate the set of burst sizes for the FID (block 609). The BS may repeat blocks 607 and 609 for each FID associated with MSs in the group of MSs (block 611).

Indicating the set of burst sizes for the FID may include the BS sending an indication of the size of the set of burst sizes selected for the FID. As an example, the BS may send a set of burst size indicator that indicates a number of burst sizes in the set of burst sizes. According to an example embodiment, the set of burst size indicator comprises a number of bits, such as zero, one, two, three, four, or any other number of bits, to indicate the number of burst sizes in the set of resource sizes. For example, if the set of burst size indicator is zero bits, then the set of burst sizes includes a single burst size, while if the set of burst size indicator is one bit, then the set of burst sizes includes two burst sizes, and so on. For example, if the set of burst size indicator is zero bits, then the set of burst sizes includes a single burst size, while if the set of burst size indicator is one bit, then the set of burst sizes includes two burst sizes, and so on. If the set of burst size indicator is zero bits in size, then there is just one burst size for the FID and there may be no need to include burst size information because the burst size may be as determined by a technical standard or provided to the MS in a message.

The BS may also send an index for each burst size in the set of burst size and an actual size of the burst size. For discussion purposes, consider set of burst sizes selected for FID one with four burst sizes: burst size one with 20 bytes, burst size two with 25 bytes, burst size three with 30 bytes, and burst size four with 35 bytes. The BS may send the FID information about its selected burst size by sending FID number; set of burst size indicator; burst size index, burst size; burst size index, burst size; and so on. Considering the above example, the sequence may be: one; two; 1, 20; 2, 25; 3, 30; 4, 35.

According to an example embodiment, the burst size index and the burst size may be provided to the MS in the form of a bit map, with a first portion of the bit map indicating the burst size index and a second portion of the bit map indicating the burst size itself. For example, consider a five-bit bit map with two bits used to indicate the burst size index and three bits used to indicate the burst size.

According to an example embodiment, in addition to or lieu of the burst size information, the BS may also send resource size information related to the burst sizes and set of burst sizes for the FID in block 609. As an example, the BS may indicate a resource size indicator for each burst size in the set of burst sizes when the BS is providing burst size information to the FID. Referencing the above presented example, the BS may The BS may send the FID information about its selected burst size by sending FID number; set of burst size indicator; burst size index, burst size, resource size; burst size index, burst size, resource size; and so on.

According to an alternative example embodiment, instead of sending the resource size information along with the burst size information, the BS may send the resource size information separate from the burst size information. As an example, the BS may initially provide the burst size information to the FID, and then subsequently provide the resource size information to the FID.

The configuration of the set of resource sizes may occur over MAC or PHY layer messages or any other type of messages. An example of a MAC message, such as an AAI_GRP-CFG message is shown below in Table 2. As shown in Table 2, a three-bit burst size indicator is used, therefore, there are a total of eight burst sizes per set of burst sizes.

TABLE 2
MAC message used to configure resource size.

| Mandatory/ | Attributes/Array of | Size | | |
|---|---|---|---|---|
| Optional | attributes | (bits) | Value/Note | Conditions |
| M | Message type | 8 | | |
| M | Deletion Flag | 1 | Flag to signal whether | |
| | | | this message includes | |
| | | | addition or deletion | |
| | | | information. | |
| | | | 0: Flow is added to a | |
| | | | group | |
| | | | 1: Flow is explicitly | |
| | | | deleted from a group | |
| M | dlUlIndicato | 1 | 0: DL allocation | |
| | | | 1: UL allocation | |
| M | FID | 4 | FID that is added to or | |
| | | | deleted from GRA group | |
| M | K) Burst&Resource- | | | |
| | Info [1..2] | | | |
| M | K.1) resource size | 3 bits | ith resource size index of | Present if |
| | index i | | the 8 resource sizes | Deletion |
| | | | supported for the FID | Flag == 0 |
| M | K.2) resource size | 4 bits | Real resource size in the | Present if |
| | for resource size index i | | number of LRUs. | Deletion |
| | | | | Flag == 0 |
| | . . . | | | |

FIG. 6b illustrates a flow diagram of operations 620 for indicating resource sizes. Operations 620 may be indicative of operations occurring in a BS as the BS indicates a resource size that it has allocated for use in transmission to a FID associated a MS that is served by the BS. Operations 620 may be an implementation of block 410 of FIG. 4a, indicate selected burst size, resource size, and/or resource offset for FIG. Operations 620 may occur while the BS is in a normal operating mode and has MSs to serve.

Operations 620 may begin with the BS selecting a resource size for a FID (block 625). According to an embodiment, the BS may select the resource size from a set of resource sizes available for use in transmissions to the FID. The BS may select the resource size for the FID based on a number of performance criteria, including but not limited to: amount of transmission to be made to FID, FID priority, FID quality of service requirements, service history for FID, current communications system traffic and load, expected communications system's load, available communications system resources, and so forth.

The BS may then send information related to the selected resource size to the MS associated with the FID (block 627). According to an example embodiment, the BS may send a number corresponding to a position or index of the selected resource size in the set of resource sizes to the MS. According to another example embodiment, the BS may send the size of the selected resource size to the MS. According to another example embodiment, the BS may send a difference between the selected resource size and a previously selected resource size to the MS. If the BS is providing resource size information to more than one FID, the BS may also send information that may be used to identify the FID along with the resource size information to the MS.

FIG. 6c illustrates a flow diagram of operation 640 for processing resource sizes. Operations 640 may be indicative of operations occurring in a MS associated with a FID as the MS receives configuration information about resource sizes from a BS that is serving the BS. Operations 640 may be an implementation of block 455 of FIG. 4b, receive configuration information about burst sizes, resource sizes, and/or resource offset. Operations 640 may occur while the MS is in a normal operating mode and is being served by the BS.

Operations 640 may include the MS receiving from the BS burst size and resource size information for a FID associated with the MS (block 645). According to an example embodiment, the MS may receive an indication of a burst size and an indication of a resource size for the burst size. The MS may receive an indication of a burst size and an indication of a resource size of the burst size for each of the burst sizes in a set of burst sizes assigned to the MS by the BS. The burst size and the resource size information may be received together or separately. For example, if the set of burst sizes assigned to the MS includes four burst sizes, then the MS may receive four indications of burst sizes and an indication of a resource size of each of the four burst sizes.

FIG. 6d illustrates a flow diagram of operations 660 for determining resource location. Operations 660 may be indicative of operations occurring in a MS as the MS determine a resource location where it should begin detection for a transmission intended for a FID associated with the MS by a BS serving the MS. Operations 660 may be an implementation of blocks 460 and 465 of FIG. 4b, receive resource indication and determine resource location. Operations 660 may occur while the MS is in a normal operating mode and is being served by the BS.

Operations 660 may begin with the MS receiving an indication of a resource size selected by the BS for the FID (block 665). According to an embodiment, the indication of the resource size selected by the BS may be an index of the selected resource size. The MS may then determine the resource location where it may begin detecting for the transmission made by the BS (block 667). According to an embodiment, the MS may determine the resource location by considering the resource size of FIDs provided by the BS transmitted in resources prior to the transmission made by the BS to the MS. As an example, consider a situation wherein the MS is the fourth in a sequence of transmission made by the BS and the first three transmissions are transmissions of resource sizes 25 bytes, 25 bytes, and 40 bytes, respectively. The MS may then determine that its resource location by combining the resource sizes of the three transmissions made by the BS prior to its transmission and an initial resource location, e.g.,

resource location=initial resource location+25+25+40.

Determining the resource location may require the MS devote processing capability that may be better served used elsewhere. Furthermore, determining the resource location at the MS may also require that the MS monitor and save a resource allocation, e.g., an A-MAP message, so that it knows burst and/or resource information for other FIDs. It may be possible for the BS to determine the resource location for a MS and provide the resource location to the MS.

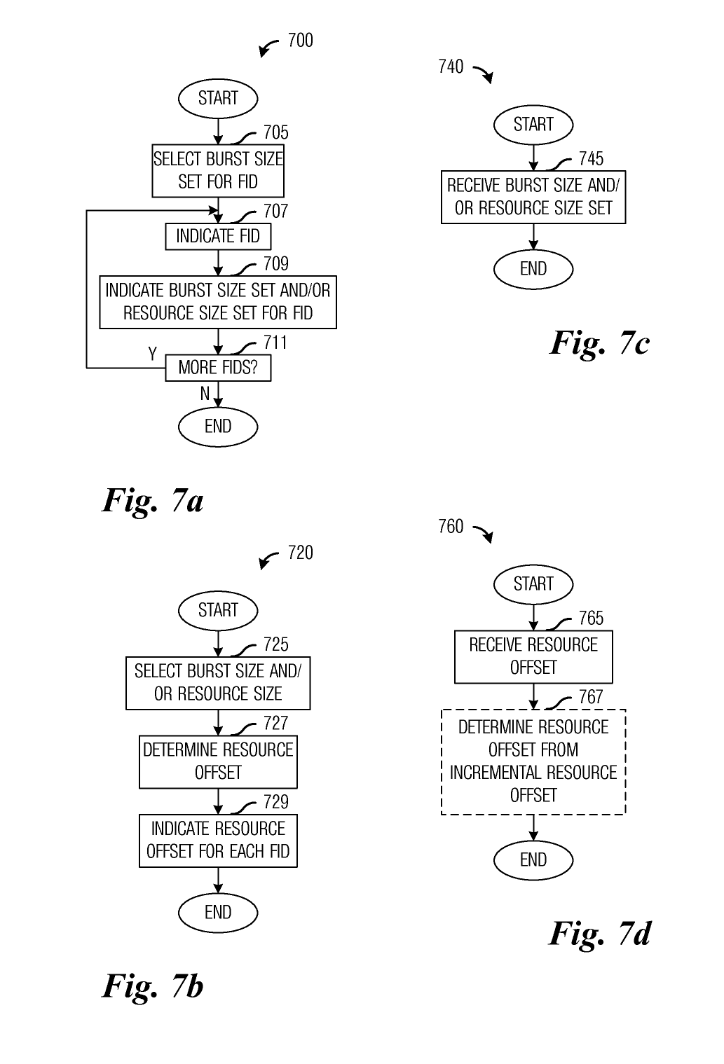

FIG. 7a illustrates a flow diagram of operations 700 for configuring burst and/or resource sizes. Operations 700 may be indicative of operations occurring in a BS as the BS configures burst and/or resource sizes for MSs served by the BS. Operations 700 may be an implementation of block 405 of FIG. 4a, configure burst sizes, resource sizes, and/or resource offset for FID. Operations 700 may occur while the BS is in a normal operating mode and has MSs to serve.

Operations 700 may begin with the BS selecting a set of burst sizes for each FID associated with MSs in a group of MSs served by the BS (block 705). According to an embodiment, the BS may select a set of burst sizes and/or resource sizes for a FID based on selection criteria such as bandwidth requirements of the FID, the FID's priority, the FID's quality of service requirements, available bandwidth of the communications system, communications system load, communications system utilization, and so on.

The BS may then send to each MS in the group of MSs associated with a FID information regarding a set of burst sizes and/or a set of resource sizes selected for the FID. As an example, the BS may send an indication of a FID (block 707) and then indicate the set of burst sizes and/or the set of resource sizes for the FID (block 709). The BS may repeat blocks 707 and 709 for each FID in the group of MSs (block 711).

FIG. 7b illustrates a flow diagram of operations 720 for indicating resource offsets. Operations 720 may be indicative of operations occurring in a BS as the BS indicates a resource size that it has allocated for use in transmission to a MS that is served by the BS. Operations 720 may be an implementation of block 410 of FIG. 4a, indicate selected burst size, resource size, and/or resource offset for FIG. Operations 720 may occur while the BS is in a normal operating mode and has MSs to serve.

Operations 720 may begin with the BS selecting a burst size and/or resource size for a FID (block 725). According to an embodiment, the BS may select the burst size and/or resource size from a set of burst sizes and/or a set of resource sizes available for use in transmissions to the FID. The BS may select the burst size and/or the resource size for the FID based on a number of performance criteria, including but not limited to: amount of transmission to be made to FID, FID priority, FID quality of service requirements, service history for FID, current communications system traffic and load, expected communications system's load, available communications system resources, and so forth.

The BS may then determine a resource offset for the FID (block 727). According to an example embodiment, the resource offset may be determined based on selected burst sizes and/or resource sizes for FIDs that are to be transmitted prior to the FID. The resource offset may also be based on a base resource offset. The resource offset may be an absolute resource offset that specifies a resource location for the FID. Alternatively, the resource offset may be a relative resource offset that is based on resource offsets of other FIDs.

The BS may then send information related to the resource offset to a MS associated with the FID (block 729). According to an example embodiment, the BS may send a numerical value corresponding to the resource offset to the MS. If the BS is providing resource offset information to more than one FID, the BS may also send information that may be used to identify the FID along with the resource offset information to the FID.

Information related to the resource offset may be provided to the FID by the BS over MAC or PHY layer message or any other type of messages. An example of a MAC Information Element (IE) message is shown below in Table 3. As shown in Table 3, a variable length message is used to provide resource offset information to the FID.

TABLE 3
MAC message used to provide resource offset information.

| Syntax | | Size (bit) | Description/Notes |
|---|---|---|---|
| Group Resource_Allocation_A- | | — | — |
| MAP_IE( ) { | | | |
| if (UL Allocation && D <U){ | | | |
| | Allocation Relevance | 1 | 0b0: Allocation in the first UL |

| | | |
|---|---|---|
| | | subframe relevant to an A-MAP |
| | | region |
| | | 0b1: Allocation in the second UL |
| | | subframe relevant to an A-MAP |
| | | region |
| } | | |
| User Bitmap | Variable | Bitmap to indicate scheduled AMSs |
| | | in a group. The size of the bitmap is |
| | | equal to the User Bitmap Size |
| | | signaled to each AMS in the Group |
| | | configuration MAC control message. |
| | | 0b0: AMS not allocated in this AAI |
| | | subframe |
| | | 0b1: AMS allocated in this AAI |
| | | subframe |
| Resource Offset | Variable | indicate resource offset for each |
| | | individual FID which present in the |
| | | user bitmap. Each resource offset for |
| | | a FID has 7 bits. There will be n*7 |
| | | bits for n FIDs present in the user |
| | | bitmap. |
| .... | | |
| .... | | |
| Resource Assignment Bitmap | Variable | Bitmap to indicate burst size/resource |
| | | size for each scheduled AMS |
| } | — | — |

FIG. 7c illustrates a flow diagram of operation 740 for processing burst sizes and/or resource sizes. Operations 740 may be indicative of operations occurring in a MS as the MS receives configuration information about resource sizes from a BS that is serving the MS. Operations 740 may be an implementation of block 455 of FIG. 4b, receive configuration information about burst sizes, resource sizes, and/or resource offset. Operations 740 may occur while the MS is in a normal operating mode and is being served by the BS.

Operations 740 may include a MS associated with a FID receiving from the BS burst size and/or resource size information selected for the FID (block 745). According to an example embodiment, the MS may receive an indication of a burst size and an indication of a resource size for the burst size. The MS may receive an indication of a burst size and an indication of a resource size of the burst size for each of the burst sizes in a set of burst sizes assigned to the MS by the BS. The burst size and the resource size information may be received together or separately. For example, if the set of burst sizes assigned to the MS includes four burst sizes, then the MS may receive four indications of burst sizes and an indication of a resource size of each of the four burst sizes.

FIG. 7d illustrates a flow diagram of operations 760 for determining resource location. Operations 760 may be indicative of operations occurring in a MS as the MS determines a resource location where it should begin detection for a transmission made to the MS by a BS serving the MS. Operations 760 may be an implementation of blocks 460 and 465 of FIG. 4b, receive resource indication and determine resource location. Operations 760 may occur while the MS is in a normal operating mode and is being served by the BS.

Operations 760 may begin with a MS associated with a FID receiving an indication of a resource offset for the FID from the BS (block 765). According to an embodiment, the indication of the resource offset selected by the BS may be an absolute resource offset or a relative resource offset. If the resource offset is a relative resource offset, then the MS may determine an absolute resource offset from the relative resource offset by combining the relative resource offset with resource offsets provided to other FIDs and a base resource offset (block 767).

According to an embodiment, it may be possible for the BS to utilize one or more of the above discussed techniques for reducing resource allocation signaling overhead. As an example, the BS may make use of FID related burst sizes, FID related and/or burst size related resource sizes, resource offset, or combinations thereof to reduce resource allocation signaling overhead as well as providing communications securing for FIDs in the group of MSs.

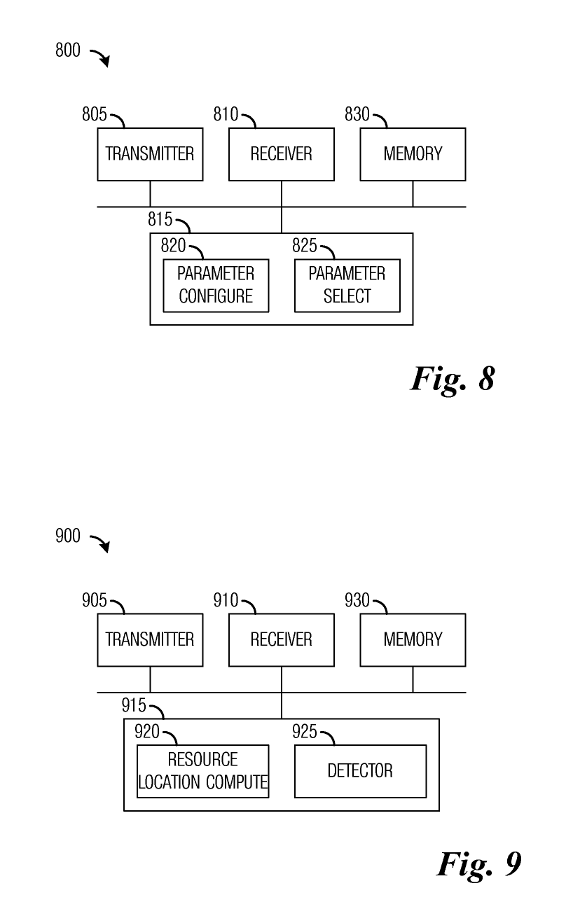

FIG. 8 provides an alternate illustration of a communications device 800. Communications device 800 may be an implementation of a base station. Communications device 800 may be used to implement various ones of the embodiments discussed herein. As shown in FIG. 8, a transmitter 805 is configured to transmit information and a receiver 810 is configured to receive information. A parameter configure unit 820 is configured to configure parameters, such as burst sizes, sets of burst sizes, resource sizes, sets of resource sizes, and so forth, for MSs in a group of MSs served by communications device 800. Parameter configure unit 820 may configure parameters based on a number of selection criteria. A parameter select unit 825 is configured to select parameters for FIDs associated with MSs in the group of MSs based on a number of performance criteria. Parameter select unit 825 is also configured to select resource offsets (absolute and/or relative). A memory 830 is configured to store parameter information, sets of parameters, selected parameters, resource offsets, selected resource offsets, and so on.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while resource configure unit 820 and resource select unit 825 may be software modules executing in a microprocessor (such as processor 815) or a custom circuit or a custom compiled logic array of a field programmable logic array.

FIG. 9 provides an alternate illustration of a communications device 900. Communications device 900 may be an implementation of a mobile station. Communications device 900 may be used to implement various ones of the embodiments discussed herein. As shown in FIG. 9, a transmitter 905 is configured to transmit information and a receiver 910 is configured to receive information. A resource location compute unit 920 is configured to determine a resource location for communications device 900 based on parameter information (such as burst sizes, sets of burst sizes, resource sizes, sets of resource sizes, and so forth) as well as resource offsets (absolute and/or relative) provided by a base station serving communications device 900. A detector 925 is configured to detect a transmission intended for communications device 900 made by the base station at the resource location determined by resource location compute unit 920. A memory 930 is configured to store information, as well as messages, and so on.

The elements of communications device 900 may be implemented as specific hardware logic blocks. In an alternative, the elements of communications device 900 may be implemented as software executing in a processor, controller, application specific integrated circuit, or so on. In yet another alternative, the elements of communications device 900 may be implemented as a combination of software and/or hardware.

As an example, receiver 910 and transmitter 905 may be implemented as a specific hardware block, while resource location compute unit 920 and detector 925 may be software modules executing in a microprocessor (such as processor 915) or a custom circuit or a custom compiled logic array of a field programmable logic array.

The above described embodiments of communications devices 800 and 900 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 4a, 4b, 5a, 5b, 5c, 5d, 6a, 6b, 6c, 6d, 7a, 7b, 7c, and 7d—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications controller operations, the method comprising for each flow in at least one flow associated with communications devices in a group of communications devices served by a communications controller,
determining a set of parameters for the flow; and
transmitting the set of parameters to a communications device associated with the flow.

2. The method of claim 1, wherein a flow comprises a message flow or a data flow.

3. The method of claim 1, wherein determining a set of parameters is based on a selection criterion and requirements of the flow.

4. The method of claim 3, wherein the selection criterion comprises bandwidth requirements of the flow, priority of the flow, quality of service requirements of the flow, available bandwidth of a communications system, load of the communications system, utilization of the communications system, or combinations thereof.

5. The method of claim 1, wherein the at least one flow comprises two flows, and wherein a first set of parameters for a first flow differs from a second set of parameters for a second flow.

6. The method of claim 1, wherein the set of parameters comprises a set of transmission sizes.

7. The method of claim 1, wherein transmitting the set of parameters comprises transmitting a transmission size index and a transmission size for the transmission size index.

8. The method of claim 7, wherein transmitting the set of parameters further comprises repeating transmitting a transmission size index and a transmission size for the transmission size index for each transmission size in the set of transmission sizes.

9. The method of claim 7, wherein transmitting a transmission size index and a transmission size for the transmission size index comprises transmitting a bit map representation of the transmission size index and the transmission size.

10. The method of claim 9, wherein a bit map representation of the transmission size index comprises a two-bit bit map, and wherein a bit map representation of the transmission size comprises a three-bit bit map.

11. The method of claim 1, wherein the set of parameters comprises a set of transmission sizes, a set of transmission resource sizes, or combinations thereof.

12. The method of claim 1, wherein transmitting the set of parameters for each flow in the at least one flow comprises transmitting a group allocation message comprising each set of parameters.

13. The method of claim 12, wherein the group allocation message is transmitted to the communications devices in the group of communications devices.

14. The method of claim 1, wherein the set of parameters is different from other sets of parameters.

15. A method for communications controller operations, the method comprising:
for each message flow in a plurality of flows associated with communications devices in a group of communications devices served by a communications controller, configuring a set of parameters for the flow, wherein the set of parameters is set based on a selection criterion and requirements of the flow;
selecting at least two flows from the plurality of flows; and
for each selected flow in the at least two flows,
selecting a parameter from a set of parameters associated with the selected flow,
transmitting an indication of the parameter to a selected communications device associated with the selected flow, and
transmitting to the selected communications device, wherein the transmitting is based on the parameter.

16. The method of claim 15, wherein the set of parameters for each flow is configured independently of other sets of parameters for other flows in the plurality of flows.

17. The method of claim 15, wherein configuring a set of parameters comprises transmitting the set of parameters to a communications device associated with the flow.

18. The method of claim 15, wherein selecting a parameter is based on performance criteria.

19. The method of claim 18, wherein the performance criteria comprises an amount of transmission to be made to the flow, priority of the flow, quality of service requirements of the flow, service history for the flow, traffic and load of a communications system, expected load for the communications system, available resources from the communications system, or combinations thereof

20. The method of claim 15, wherein the set of parameters comprises a set of transmission sizes, and wherein transmitting an indication comprises transmitting an indication of an index of a selected transmission size.

21. The method of claim 15, wherein transmitting an indication of the parameter comprises:
selecting a resource offset; and
transmitting the selected resource offset to the selected communications device.

22. The method of claim 21, wherein the selected resource offset comprises an absolute resource offset or a relative resource offset.

23. The method of claim 15, wherein the set of parameters comprises a set of transmission sizes and a set of transmission resource sizes, and wherein transmitting an indication comprises transmitting an indication of an index of a selected transmission size and an indication of an index of a selected transmission resource size.

24. A communications controller comprising:
a parameter configure unit configured to configure a set of parameters for each flow in a plurality of flows associated with communications devices in a group of communications devices served by the communications controller, wherein each set of parameters is based on selection criteria and requirements of an associated flow;
a parameter select unit coupled to the parameter configure unit, the parameter select unit configured to select a parameter from a set of parameters assigned to a flow in the plurality of flows; and
a transmitter coupled to the parameter configure unit and to the parameter select unit, the transmitter configured to transmit the sets of parameters to a first plurality of communications devices associated with the plurality of flows in a first group allocation message and to transmit a selected parameter to a second plurality of communications devices.

25. The communications controller of claim 24, wherein the parameter configure unit is configured to configure a set of parameters independently for each flow in the plurality of flows.

26. The communications controller of claim 24, wherein the selected parameter is selected based on a performance criteria.

27. The communications controller of claim 24, wherein the set of parameters comprises a set of transmission sizes, and wherein the transmitter transmits a selected parameter by transmitting a indication of an index of a selected transmission size.
